(19) United States
(12) Patent Application Publication
(10) Pub. No.: US 2008/0022973 A1
(43) Pub. Date: Jan. 31, 2008

(54) Limiting pump flow during overspeed self-actuation condition

(76) Inventors: Daniel R. Puckett, Peoria, IL (US); Scott F. Shafer, Morton, IL (US); Frank Lombardi, Metamora, IL (US)

Correspondence Address: CATERPILLAR c/o LIELL & MCNEIL ATTORNEYS PC, P.O. BOX 2417, 511 SOUTH MADISON STREET, BLOOMINGTON, IN, 47402-2417, US

(21) Appl. No.: 11/496,701

(22) Filed: Jul. 31, 2006

(51) Int. Cl. F02M 57/02; F02M 37/04

(52) U.S. Cl. 123/446; 123/506

(57) ABSTRACT

In an engine equipped with a common rail fuel injection system, the engine can sometimes experience an overspeed condition, and the pump may respond to this overspeed condition with self-actuation even in the absence of any control signal. In order to prevent an over pressurization condition, a liquid supply into a pumping chamber of the pump is limited during a retraction stroke of a pump plunger by energizing an electrical actuator coupled to a spill valve, to move the spill valve toward a closed position. The electrical actuator is de-energized during a pumping stroke of the pump plunger to allow the spill valve to more toward an open position. Liquid from the pumping chamber is discharged through the spill valve during the pumping stroke, but over pressurization is avoided by limiting the amount of liquid that can enter the pumping chamber during the retraction stroke.

### TECHNICAL FIELD

The present disclosure relates generally to liquid pumps that are electronically controlled but have an overspeed self actuation mode, and more particularly to limiting pump flow during an overspeed self-actuation condition.

### BACKGROUND

Many internal combustion engines are equipped with common rail fuel injection systems. In these systems, a high pressure liquid pump will typically receive pressurized fuel from a transfer pump which draws fuel from a low pressure reservoir. The high pressure pump pressurizes it to injection levels and supplies the same to a common rail. A plurality of individual fuel injectors are fluidly connected to the common rail and provide the means by which fuel is injected into individual cylinders of the engine. These pumps will typically be electronically controlled in order to control output from the pump independent of engine speed and hence control rail pressure through appropriate electronic signals generated by a conventional electronic controller. These pumps are typically driven directly via a gear train connection to the engine's crank shaft. However, the pump's output is generally controlled via an electronically controlled valve that determines how much of each pumping stroke produces output to the common rail. Some pumps in this class also include a passive pressure relief valve that opens when pressures rise above some certain threshold to prevent over pressurization damage to the pump or elsewhere in the common rail fuel injection system. Although some pumps in this class are equipped with pressure relief valves, the pressure relief valve will have an inherent flow rate capacity. Therefore, it is important that the pump be operated in a way that prevents the pressure relief valve from being overwhelmed by exceeding its flow capacity under all anticipated operating conditions for the pump.

In some rare circumstances, an engine will experience a so called “overspeed” condition. One example overspeed condition might be when an over the road truck is utilizing the engine to apply a retarding force to the truck when traveling down hill. In such a condition, the engine speed can rise above an RPM level associated with an overspeed condition, such as in the range of 3000-4000 RPM. In this range, engineers have observed that some common rail high pressure pumps will experience a self-actuation mode where liquid flow and/or other forces within the pump itself cause the output control valve to self actuate, resulting in the pump producing substantial output even when no control signal commanding output is present. For instance, some liquid pumps of common rail fuel systems utilize a latching spill valve that relies upon hydraulic latching to hold the spill valve closed during normal pump operations during a pumping stroke. This is typically accomplished by including a spill valve that moves toward a closed position in a direction away from a pumping chamber and includes a closing hydraulic surface exposed to fluid pressure in the pumping chamber of the pump. During a self-actuation mode, fluid flow around the spill valve can pull it closed when no control signal is present to pull the spill valve closed via a conventional electrical actuator. Thus, under these overspeed conditions, the common rail may be asking for no fluid, yet the pump is operating at a high speed producing a substantial amount of output. In some instances, there may be a danger of an over pressurization condition if the pressure relief valve capacity is exceeded.

U.S. Pat. No. 5,277,156 to Osuka et al. teaches a high-pressure pump that does not include a pressure relief valve but does have a strategy for dealing with a potential self-actuation overspeed condition. Like the pump discussed earlier, the Osuka et al. pump includes a latching spill/fill valve that allows for the spill valve to be actuated with a brief electric current rather than supplying current to the same for the entire duration of a pumping stroke. In those rare instances when the Osuka et al. system detects a self-actuation overspeed condition, a special logic in the electronic controller is initiated that supplies electrical current continuously to hold the spill/fill valve closed during the entire retraction and pumping stroke until the overspeed condition subsides. Thus, during normal operating conditions, the Osuka et al. pump needs to be provided only brief bursts of electrical current in order to provide normal output control from the pump. However, during an overspeed self-actuation condition, the Osuka et al. system must provide continuous electric current to the electrical actuator for each of a plurality of electronically controlled spill/fill valves simultaneously during their entire retraction and pumping strokes. Thus, the Osuka et al. system suffers from a potential drawback by requiring the ability to provide a substantial amount of electrical power simultaneously to a plurality of electrical actuators associated with its high-pressure pump.

The present disclosure is directed to one or more of the problems set forth above.

### SUMMARY OF THE DISCLOSURE

In one aspect, a method of operating a liquid pump includes a step of rotating a pump drive shaft in excess of a spill valve self-actuation speed. A liquid supply through the spill valve is restricted into the pumping chamber of the pump during a retraction stroke of a pump plunger by energizing an electrical actuator coupled to the spill valve to move the spill valve toward a closed position. The electrical actuator is de-energized during the pumping stroke of the pump plunger to allow the spill valve to move toward an open position. Liquid from the pumping chamber is discharged through the spill valve during the pumping stroke.

In another aspect, a common rail fuel injection system includes a plurality of fuel injectors fluidly connected to a common rail. A high-pressure pump is fluidly positioned between a low-pressure reservoir and a high-pressure common rail. An electronic controller is configured to limit, but no eliminate, flow into and out of the plunger cavity through a spill valve of the pump when a drive shaft speed of the pump exceeds a spill valve self actuation speed.

In still another aspect, an engine includes a high-pressure pump with a drive shaft geared to rotate with an engine crankshaft. The high-pressure pump also includes a pressure relief valve and is fluidly connected to a high-pressure common rail. A plurality of fuel injectors are also connected to the high-pressure common rail. The engine also includes a low-pressure reservoir. Finally, there includes means for limiting flow through the pressure relief valve below its capacity when the engine is in an overspeed condition. The means for limiting includes an electronic controller coupled to an electronically controlled valve, which is different from the pressure relief valve, and is fluidly positioned between the low pressure reservoir and the plunger cavity of the high pressure pump.

### BRIEF DESCRIPTION OF THE DRAWINGS

FIG. 1 is a schematic view of an engine that includes a partially sectioned perspective view of a high pressure common rail pump;

FIG. 2 is a flow diagram of a pump output limiting overspeed algorithm according to one aspect of the present disclosure;

FIG. 3 is a graph of a control signal to an electronically controlled valve for one pumping chamber of the pump shown in FIG. 1;

FIG. 4 is a graph of pump plunger position verses time for one pumping chamber of the pump of FIG. 1;

FIG. 5 is a graph of control signal verses time for a second electronically controlled valve associated with a second pumping chamber of the pump of FIG. 1; and

FIG. 6 is a graph of a second pump plunger position verses time for the pump of FIG. 1.

### DETAILED DESCRIPTION

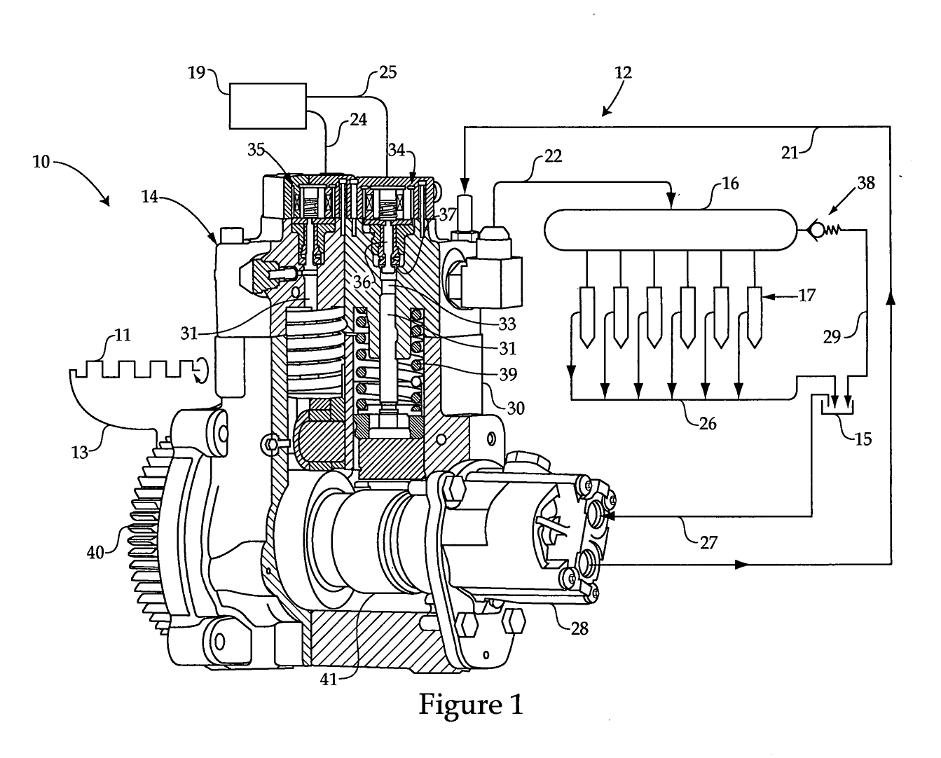

Referring to FIG. 1, an engine 10 includes a common rail fuel injection system 12 with a high-pressure liquid pump 14 and a plurality of fuel injectors 17. Pump 14 is driven directly by engine 10 via a gear train linkage 13 between crankshaft 11 and pump drive shaft 40. The pump low-pressure fuel from transfer pump 28 via a transfer line 21. The transfer pump 28 draws fuel from a low-pressure reservoir 15 via a low-pressure supply line 27. High pressure pump 14 supplies high-pressure fuel to a common rail 16 via a high-pressure outlet passage 22. Fuel injectors 17 are fluidly connected to high pressure common rail 16 in a conventional manner, and each fuel injector is fluidly connected to low pressure reservoir 15 via a low pressure return line 26.

In the illustrated embodiment, pump 14 includes a pair of pumping plungers 31 and 32 that reciprocate out of phase with one another in response to rotation of cams 41 in a conventional manner. Output from high-pressure pump 14 is controlled via an electronic controller 19 in communication with respective first and second electronically control valves 34 and 35 via communication lines 24 and 25, respectively. In order to prevent overpressurization of system 12, rail 16 includes a pressure relief valve 38 that opens above some predetermined pressure, such as the maximum desired rail pressure. Thus, when pressure in the rail 16 is above the predetermined pressure, pressure relief valve 38 will open and allow the excess liquid to be returned toward low pressure reservoir 15 via low pressure line 29 in a conventional manner.

Since the control and pumping features associated with both the first and second pumping plungers 31 and 32 are identical, the specific features of only one will be described. In particular, pumping plunger 31 reciprocates in a barrel 30 to displace fluid into and out of plunger cavity 33. Electronically controlled spill valve 34 includes a spill valve member 36 of the latching type that is normally biased out of contact with seat 37 via spring 43, but may be pulled closed by briefly energizing electrical actuator 42 (e.g., solenoid) during a pumping stroke. In the illustrated embodiment, plunger cavity 33 both fills and spills via electronically controlled valve 34. In particular, during a retraction stroke, low pressure fuel moves via internal passage ways connected to transfer line 21 past spill valve member 36 and into plunger cavity 33. During a pumping stroke, when spill valve member 36 is biased towards its normally open position, the fluid is then displaced back toward transfer line 21 past spill valve member 36 and seat 37. Plunger 31 is made to retract via a return spring 39 that insures that the plunger follows the surface of cam 41 in a conventional manner. Although the illustrated embodiments show filling and spilling into plunger cavity 31 occurring through the same electronically controlled valve, those skilled in the art will appreciate that the present disclosure also applies to the pump having a separate fluid passage way for filling and a separate electronically controlled spill valve, such as that shown in co-owned U.S Patent Application Publication 20040109768.

### INDUSTRIAL APPLICABILITY

The present disclosure relates to any liquid pump that is electronically controlled, but may have a mode at high speeds where self-actuation of the pump occurs. Although the present disclosure illustrates a liquid pump who's output is controlled via a latching spill valve, other pumping and output control mechanisms would fall within the scope of the present disclosure if they exhibit a self-actuation mode where fluid flow forces or other phenomenon (e.g. centripetal force) cause an output control mechanism to self-actuate in the absence of a control signal.

During normal operations of engine10, crankshaft 11 rotates and results in reciprocation of pump plungers 31 and 32 via pump drive shaft 40 and cams 41. The fuel injection system 12 will typically include a plurality of sensors, including possibly rail pressure sensor, engine speed sensor and others known in the art to determine a timing and quantity of fuel to inject from each of the plurality of fuel injectors 17 in a conventional manner. In addition, the electronic controller will determine a desired injection pressure at which to control the pressure in common rail 16 using known electronic controlling strategies. Although the pumping plungers 31 and 32 will reciprocate through a fixed distance with each rotation of the lobes of cam 41, only a portion of that fluid displacement may be needed in order to maintain rail pressure at a desired level. Thus, the electronic controller 19 also determines a timing at which electronically controlled spill valves 34 and 35 should be actuated to close the respective spill valve during a pumping stroke so that pressure builds within the plunger cavity 33 and fluid is displaced into high pressure outlet passage 22 past an outlet check valve (not shown) that is positioned between the plunger cavity 33 and common rail 16. When electrical actuator 42 is energized during a pumping stroke, spill valve 36 is pulled upward to close in contact with seat 37. Thereafter, pressure quickly builds within plunger cavity 33 and the fluid pressure itself holds the spill valve member 36 closed allowing the liquid to be displaced toward common rail 16. Thus, only a brief energization of electrical actuator 42 during a pumping stroke is needed, and after the valve is closed via the electrical actuator 42 may be de-energized for the remaining duration of the pumping stroke. After the plunger 31 reaches top dead center and begins its retraction stroke, pressure drops in plunger cavity 33 allowing spill valve member 36 to move toward an open position via the action of biasing spring 43. During the retraction stroke, fresh fluid is drawn into plunger cavity 33 past spill valve member 36. When pumping plunger 31 reaches its bottom dead center position and reverses direction for another pumping stroke, the liquid is initially displaced back toward transfer line 21 past spill valve member 36. When electronic controller 19 determines at some point during the pumping stroke that a portion of the fluid displaced by plunger 31 needs to be supplied to high pressure rail 16 to maintain its pressure, the electrical actuator 42 will be energized and the spill valve member pulled to close in contact with seat 37. Thus, those skilled in the art will appreciate that during normal operations of engine 10, fuel is consumed from high pressure rail 16 by fuel injectors 17 and replenished by high pressure pump 14 to control rail pressure to some desired level, which may vary across the engine's operating range.

In some instances during the operation of engine 10, pressure in the common rail 16 may rise to a predetermined maximum level and any further fluid in the plunger cavity 33 that is above that pressure may be displaced to rail 16 and out of pressure relief valve 38 to prevent overpressurization of system 12. However, depending upon the flow area and other factors relating to pressure relief valve 38, there may be a limit to how much flow can be pushed through the pressure relief valve. In other words, if there is so much fluid being displaced at such high-pressure levels from the plunger cavities, pressures could conceivably continue to rise to undesirable overpressurization levels even when the pressure relief valve 38 is open. For instance, one such condition might occur when engine 10 is experiencing an overspeed condition. In such a case, the electronic controller may be commanding the fuel injectors 17 to stop injecting fuel, pressure in the common rail 16 is at a relatively high and stable level, and thus, little to no liquid fuel is demanded from pump 14 in order to maintain pressure in the common rail. However, because pump 14 and engine 10 are in an overspeed condition, self-actuation of electronically controlled spill valves 34 and 35 can occur due to flow forces around valve member 36 past seat 37. When this occurs, shortly after the plunger begins its pumping stroke, the high rate of liquid flow past valve member 36 causes it to move upward and close seat 37 causing pressure to quickly rise within plunger cavity 33. However, pressure relief valve 38 may not have sufficient capacity to handle the high flow rate of high pressure from the plunger cavities during and overspeed condition. The present disclosure addresses this potential problem via selective use of electronic controller 19 to actuate the electronically controlled spill valves 34 and 35 in a way that reduces potential flow through pressure relief valve 38 to manageable levels within its capacity, even in an overspeed condition.

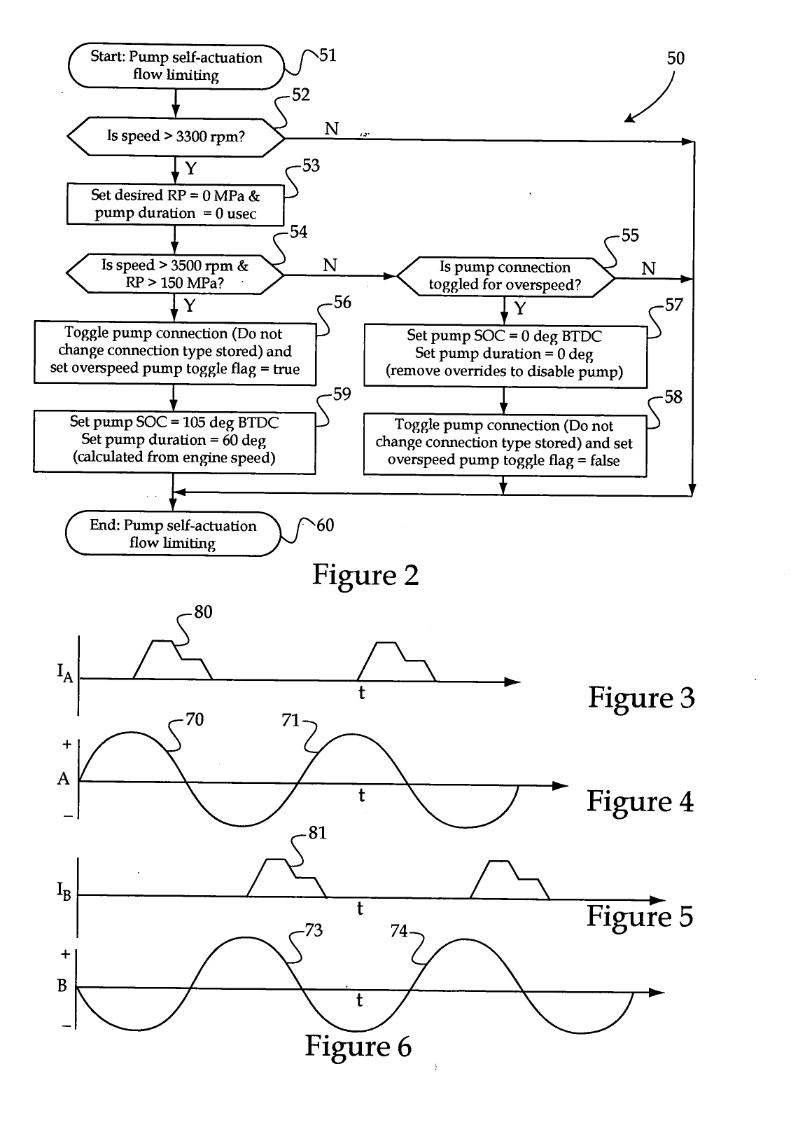

Referring now in addition to FIGS. 2-6, the electronic controller 19 of FIG. 1 may include a conventional processor configured to execute programming code stored in memory in a conventional manner, or maybe a dedicated electrical circuitry that is configured to perform in a similar manner. In the illustrated embodiment of FIG. 2, electronic controller would be configured to include the pump output limiting overspeed algorithm 50 that controls pump 14 in a manner so as to limit flow through pressure relief valve 38 below its capacity when engine 10 is in an overspeed condition. Those skilled in the art will appreciate that each individual pump application may have a unique speed at which the self-actuation phenomenon begins to occur, and at what higher speed its pressure relief valve could be overwhelmed. The overspeed algorithm begins at a start 51 and proceeds to a speed condition query 52. At this step, the controller 19 determines whether pump speed, which is linked to, but may be different from, engine speed is above a certain level where the pump self-actuation can occur. If not, the algorithm proceeds to end 60. Thus, during normal operation of engine 10, the overspeed algorithm will be circumvented by a negative response to speed query 52. However, if the engine happens to be operating in an overspeed condition reflective of a possible self-actuation speed for pump 14, the algorithm will proceed to set flags at step 53. In particular, the algorithm will set the desired rail pressure to zero and set the pump output duration to zero. Thus, the result of step 53 is to leave electronically controlled spill valves 34 and 35 unenergized so that the pump is commanded to produce no output. When the spill valves are left deactivated at moderate speeds, no output is produced since the fuel is displaced back and forth between plunger cavity 33 and low pressure supply line 21. The algorithm then proceeds to a speed and pressure query step 54 where it is determined whether the pump is operating at a speed that is not only above a self-actuation level, but is also above a level that exceeds the capacity of the pressure relief valve 38. In addition, query 54 determines whether rail pressure is above some predetermined high-pressure level. If not, this would be an indication that in the self-actuation mode that there is capacity in both the common rail and the pressure relief valve to handle the fluid being displaced from the plunger cavities in this overspeed condition, and the algorithm will proceed to flag check query 55. At query 55, the algorithm checks to see if the pump overspeed flag has been toggled to a true condition. If not, the algorithm again proceeds to end 60.

If the pump overspeed flag is determined to be true, the algorithm proceeds to set or reset parameters at step 57. At step 57, the pump is reenabled, although the pump output is set to zero. At step 58, the pump overspeed flag is set to false and the algorithm proceeds to end 60. Returning to query 54, if the controller determines that the pump is operating at such a high speed as to be in a self-actuation mode that will overwhelm the pressure relief valve 38, and rail pressure is at or above some elevated level, the algorithm will proceed to step 56 where the pump overspeed flag is set to true. When this occurs, the algorithm will then proceed to step 59 where the control signals to the electronically controlled spill valves are set in a manner reflected by the graphs of FIGS. 3-6. In particular, when in this high overspeed condition, electronic controller will be set to command the electronically controlled spill valves to close during a portion, but not all of, the retraction stroke preventing liquid from entering the plunger cavity past the spill valve member 36. While this action permits some displacement of liquid into and out of plunger cavity past spill valve member 36, overpressurization is avoided since the plunger cavity 33 is starved of liquid due to the closure of spill valve 36 during the retraction stroke. This action may result in cavitation within the pump during these pressure overspeed self-actuation conditions.

FIGS. 3-6 reflect the control signals (FIGS. 3 and 5) and the plunger motion (FIGS. 4 and 6) of the pumping plungers 31 and 32 associated with pump 14 of FIG. 1 as controlled via overspeed algorithm 50 shown in FIG. 2. In particular, a control signal 80 will cause the electrical actuator 42 to be energized 80 during a majority but less than all of the retraction stroke 70. For example, the electronic controller may command the electronically controlled valve to close at about 150 degrees before top dead center and then maintain valve 34 closed for about 60 degrees or about two thirds of the retraction stroke. In addition, the initial timing of closing the valve and or the duration of the closure may be made a function of the engine speed. For instance, at higher speeds, the duration of valve closure during the retraction stroke may be increased. This will prevent too much liquid from entering plunger cavity 33 and thus avoid overwhelming pressure relief valve 38 in the overspeed self-actuation condition. Thus, when the pump plunger 31 undergoes its pumping stroke 71, a substantial portion of that stroke will be merely reflected by collapse of cavitation bubbles generated during the retraction stroke, and very little liquid displacement into and out of plunger cavity 33 past spill valve member 36 will occur, and any liquid displaced through pressure relief valve 38 will be well within its capacity. Typically, the electrical actuator will be de-energized before an end of the retraction stroke 70. When this occurs, liquid may flow into plunger cavity 33, but that flow will quickly reverse in an opposite direction when the plunger begins its pump stroke 71 and the self-actuation conditions arise. The action of the other pumping plunger 32 and its associated electrically controlled spill valve 35 are illustrated in FIGS. 5 and 6 which are identical to that of the first pumping plunger, except out of phase with the same. In other words, the electrical actuator associated with electronically controlled spill valve 35 will receive a stepped control signal 81 that includes a pull in current and then a hold in current to hold its spill valve closed during a majority of the retraction stroke 73. Thereafter, the electrical actuator is de-energized for the duration of the pumping stroke 74.

The strategy to prevent overpressurization reflected in the present disclosure includes a number of subtle but important advantages. First, it allows the pressure relief valve 38 to be sized to respond to almost all normal operating conditions, rather than having its design and capacity completely driven by the rare occurrences when an overspeed self-actuation condition could occur at high rail pressures. Thus, the present disclosure could represent a relatively inexpensive software fix to a problem that might otherwise need to be addressed with relatively expensive high capacity pressure relief valve, that could itself drive a complete redesign of an otherwise useful pump. In addition, the strategy of the present disclosure avoids any need to enlarge the electrical capacity of the drivers supplying current to the electrical actuators associated with pump 14. This is best illustrated in FIGS. 3 and 5 where each of the electrical actuators are energized individually, and never at the same time, but merely out of phase with the way they would normally be electrically actuated during normal engine operation modes. Thus, the strategy of the present disclosure does not overtask or require resizing of the electronic system that supplies current energy to the electrical actuators that control the electronically control spill valves 34 and 35.

It should be understood that the above description is intended for illustrative purposes only, and is not intended to limit the scope of the present invention in any way. Thus, those skilled in the art will appreciate that other aspects, objects, and advantages of the invention can be obtained from a study of the drawings, the disclosure and the appended claims.

What is claimed is:

1. A method of operating a liquid pump, comprising the steps of:
rotating a pump drive shaft in excess of a spill valve self actuation speed;
restricting a liquid supply through the spill valve into a pumping chamber of the pump during a retraction stroke of a pump plunger by energizing an electrical actuator coupled to the spill valve to move the spill valve toward a closed position;
de-energizing the electrical actuator during a pumping stroke of the pump plunger to allow the spill valve to move toward an open position; and
discharging liquid from the pumping chamber through the spill valve during the pumping stroke.

2. The method of claim 1 wherein the discharging step includes displacing liquid from the pumping chamber through a pressure relief valve.

3. The method of claim 1 wherein the restricting step includes a step of holding the spill valve closed for a majority, but less than all, of the retraction stroke.

4. The method of claim 1 including a step of de-energizing the electrical actuator before an end of the retraction stroke.

5. The method of claim 1 including a step of refraining from performance of the restricting step if an output pressure downstream from the pump is less than a predetermined threshold pressure.

6. The method of claim 1 including a step of de-energizing the electrical actuator during the entire retraction and pumping strokes of the pump plunger in a pre-self-actuation speed range immediately preceding the self actuation speed.

7. The method of claim 6 wherein the discharging step includes displacing liquid from the pumping chamber through a pressure relief valve;
the restricting step includes a step of holding the spill valve closed for a majority, but less than all, of the retraction stroke; and
de-energizing the electrical actuator before an end of the retraction stroke.

8. The method of claim 7 including a step of refraining from performance of the restricting step if an output pressure downstream from the pump is less than a predetermined threshold pressure.

9. The method of claim 1 including a step of energizing a plurality of electrical actuators associated with different plunger cavities of the pump out of phase with one another so that no two electrical actuators are energized simultaneously.

10. A common rail fuel injection system comprising:
a high-pressure common rail;
a plurality of fuel injectors fluidly connected to the common rail;
a low pressure reservoir;
a high pressure pump fluidly positioned between the low pressure reservoir and the high pressure common rail; and
an electronic controller configured to limit, but not eliminate, flow into and out of a plunger cavity through a spill valve of the pump when a drive shaft speed of the pump exceeds a spill valve self actuation speed.

11. The system of claim 10 wherein the electronic controller is configured to limit flow from the plunger cavity through a relief valve below a flow capacity of the relief valve.

12. The system of claim 10 wherein the electronic controller is configured to actuate the spill valve to close over a majority, but less than all, of a retracting stroke of a plunger of the pump.

13. The system of claim 12 wherein the electronic controller is configured to maintain the spill valve deactivated during the entire retraction and pumping strokes of the plunger in a pre-self-actuation speed range immediately preceding the self actuation speed.

14. The system of claim 10 wherein the electronic controller is configured to return to a regular operation mode when the drive shaft speed and a pressure in the common rail drop below respective thresholds.

15. An engine comprising:
an engine crankshaft;
a high pressure pump with a drive shaft geared to rotate with the engine crankshaft, and including a pressure relief valve;
a high-pressure common rail fluidly connected to an output from the high-pressure pump;
a plurality of fuel injectors fluidly connected to the high-pressure common rail;
a low pressure reservoir; and
means for limiting flow through the pressure relief valve below a capacity of the pressure relief valve when the engine is in an overspeed condition, and the means for limiting including an electronic controller coupled to an electronically controlled valve, which is different from the pressure relief valve, fluidly positioned between the low pressure reservoir and a plunger cavity of the high pressure pump.

16. The engine of claim 15 wherein the means for limiting includes an electronic controller with a pump output limiting overspeed algorithm that is executed when the engine is in an overspeed condition.

17. The engine of claim 16 wherein pump output limiting overspeed algorithm of the electronic controller is configured to limit, but not eliminate, flow into and out of a plunger cavity through the electronically controlled valve when a drive shaft speed of the pump exceeds a spill valve self actuation speed.

18. The engine of claim 17 wherein pump output limiting overspeed algorithm of the electronic controller is configured to actuate the electronically controlled valve to close over a majority, but less than all, of a retracting stroke of the plunger of the pump.

19. The engine of claim 18 wherein the electronic controller is configured to maintain the electronically controlled valve deactivated during the entire retraction and pumping strokes of the plunger in a pre-self-actuation speed range immediately preceding the self actuation speed.

20. The engine of claim 19 wherein the electronic controller is configured to return to a regular operation mode when the drive shaft speed and a pressure in the common rail drop below respective thresholds.
